(19) United States
(12) Patent Application Publication
(10) Pub. No.: US 2012/0002238 A1
(43) Pub. Date: Jan. 5, 2012

(54) IMAGE PROCESSING SYSTEM, IMAGE PROCESSING METHOD, AND STORAGE MEDIUM

(75) Inventors: Mario ITO, Kawasaki-shi (JP); Naobumi Fukudome, Yokohama-shi (JP)

(73) Assignee: CANON KABUSHIKI KAISHA, Tokyo (JP)

(21) Appl. No.: 13/171,757

(22) Filed: Jun. 29, 2011

(30) Foreign Application Priority Data
Jul. 1, 2010 (JP) 2010-151107

(51) Int. Cl. G06K 15/02

(52) U.S. Cl. 358/1.15

(57) ABSTRACT

An image processing system applies an image processing job to received image information according to contents of previously created definition information. The image processing system comprises an image forming apparatus configured to receive image information, associated with user information for specifying a user, through a public line an information processing unit configured to previously generate process definition in which a process to be executed by the image forming apparatus is described, and a storage unit configured to store the process definition previously generated by the information processing unit. The image forming apparatus has an acquisition unit configured to specify the user based on the user information extracted from the received image information and acquire the process definition associated with the user. The image processing system further comprises a processing unit configured to execute the contents of processing described in the process definition associated with the user acquired by the acquisition unit.

### BACKGROUND OF THE INVENTION

1. Field of the Invention

The present invention relates to an image processing system, an image processing method, and a storage medium, and particularly relates to an image processing system, an image processing method, and a storage medium, which execute a process described in a previously generated process definition.

2. Description of the Related Art

There have been recently increased requirements to computerize and accumulate document data for the purpose of viewing, searching, and processing a document at high speed and easily.

Thus, the following image processing system has been considered, for example. In the image processing system, the performances of an image processing device and a processing server are obtained to create an image processing job, and definition files of the image processing processes are stored in a storage device (for example, a directory service such as Active Directory).

The image processing device then acquires the definition file of the image processing job from the storage device to scan an image according to the definition of the image processing job and thus transmit the definition file of the image processing job and the scanned image to a processing execution server. The processing server having received the scanned image performs image processing according to the definition of the image processing job. Consequently, the user's burden can be reduced, and documents can be computerized and accumulated efficiently.

As a conventional device having a FAX function, there has been proposed a device having a function of transferring FAX-received data by means such as e-mail according to setting information previously stored in the device. The device having the FAX function has the transfer function, whereby a user's convenience is enhanced in the document management (see Japanese Patent Application Laid-Open No. 9-200482, for example).

However, in the above image processing system, a user should operate the device when selects the definition of the image processing job to be used. Thus, on the above image processing system, processing such as FAX transfer cannot be realized without requiring user's troublesome. Moreover, in the above FAX transfer technique, since post-processing other than the FAX transfer cannot be executed simultaneously, there is a problem that it is burdensome for a user.

### SUMMARY OF THE INVENTION

The present invention provides an image processing system, an image processing method, and a storage medium, which apply an image processing job to received image information according to contents of previously created definition information.

In an aspect of the present invention, there is provided an image processing system comprising: an image forming apparatus configured to receive image information, associated with user information for specifying a user, through a public line; an information processing unit configured to previously generate process definition in which a process to be executed by the image forming apparatus is described; and a storage unit configured to store the process definition previously generated by the information processing unit, wherein the image forming apparatus has an acquisition unit configured to specify the user based on the user information extracted from the received image information and acquire the process definition associated with the user, and the image processing system further comprising a processing unit configured to execute the contents of processing described in the process definition associated with the user acquired by the acquisition unit.

According to the present invention, it is possible to apply an image processing job to received image information according to the contents of previously created definition information.

Further features and advantages of the present invention will become apparent from the following detailed description of exemplary embodiments with reference to the attached drawings.

### BRIEF DESCRIPTION OF THE DRAWINGS

FIG. 1 is a view which is useful in explaining a hardware configuration of an image processing system according to an embodiment of the present invention.

FIG. 2 is a block diagram showing a hardware configuration of the image forming apparatus of FIG. 1.

FIG. 3 is a block diagram showing each hardware configuration of a ticket management server and a processing server of FIG. 1.

FIG. 4 is a block diagram showing a hardware configuration of a ticket generation client of FIG. 1.

FIG. 5 is a view which is useful in explaining a configuration of a ticket generated by the ticket generation client of FIG. 1.

FIG. 6 is a view which is useful in explaining a configuration of a user information reference table utilized by the image processing system of FIG. 1.

FIG. 7 is a flowchart showing the procedure of a FAX reception transfer processing that is executed by the image forming apparatus of FIG. 2.

FIG. 8 is a flowchart showing the procedure of a ticket execution processing that is executed by the processing server of FIG. 3.

### DETAILED DESCRIPTION OF THE EMBODIMENT

The present invention will now be described in detail with reference to the drawings.

[System Configuration]

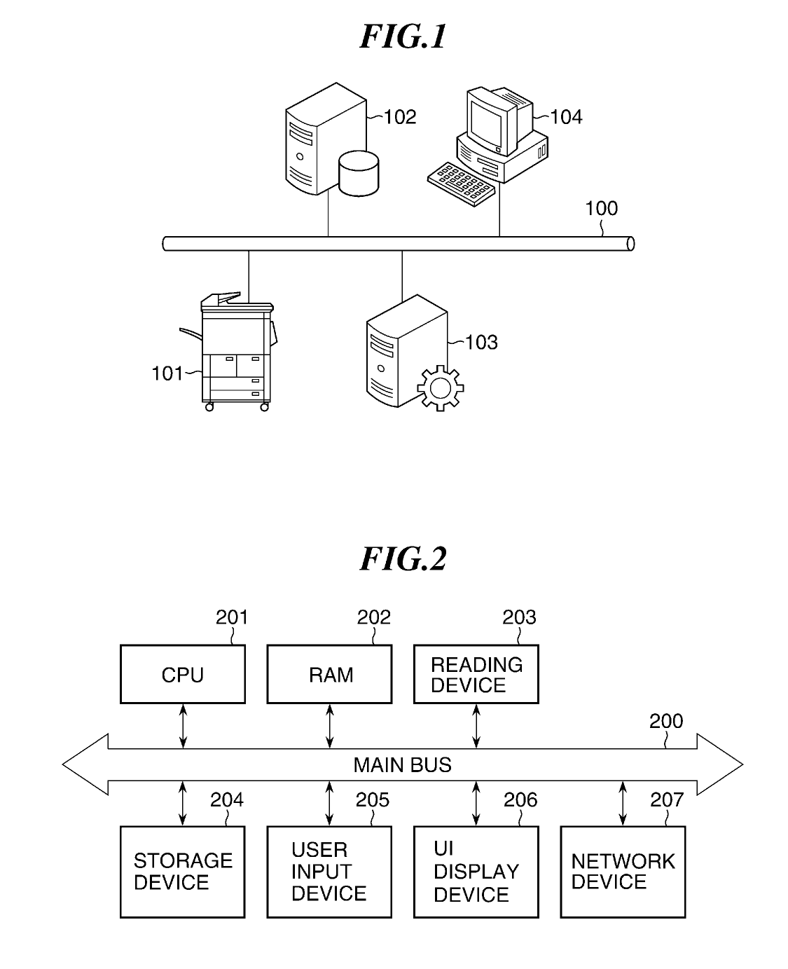

FIG. 1 is a view which is useful in explaining a hardware configuration of an image processing system according to an embodiment of the present invention.

As shown in FIG. 1, the image processing system according to the embodiment of the present invention has an image forming apparatus 101 (acquisition unit), a ticket management server 102 (storage unit), a processing server 103 (processing unit), and a ticket generation client 104 (image processing unit), which are connected to one another through a network 100.

The network 100 is a base for communication between apparatuses and can utilize intranet, the Internet, or other network systems.

The image forming apparatus 101 is configured to enable to execute a facsimile sending and receiving processing through a public line (not shown). As the image forming apparatus 101, an MFP (Multiple Function Peripheral) may be used as long as it has a function capable of receiving FAX (or a fax service using the Internet).

As the ticket management server 102, the other unit such as a directory service (for example, an active directory) may be used as long as it can store and acquire data.

In the present embodiment, a process definition file 500 (hereinafter referred to as “the ticket”) in which the contents of the processing executed in the image forming apparatus 101 and the processing server 103 are described is created. The configuration of the ticket will be described later using FIG. 5.

The ticket generated in the ticket generation client 104 is stored in the ticket management server 102. The processing content to be described in the ticket includes setting of resolution, size, and so on used when image data is read and the subsequent processing (such as e-mail transmission, file transmission, FAX transmission, and OCR processing). For example, the ticket generation client 104 generates the definition of a process described with an image processing process such as FAX transmission to be executed corresponding to each user's terminal from the image forming apparatus 101 as the subsequent processing.

The processing server 103 is a server system having a function of processing data such as images and files (the processing including e-mail transmission, file transmission, FAX transmission, and OCR processing).

The ticket generation client 104 is a PC used in an office, for example. The ticket generation client 104 receives an instruction from a user to create the ticket of FIG. 5 to be described later, and thus, to register the ticket in the ticket management server 102 through the network 100.

In this system, the image forming apparatus 101, the processing server 103, and the ticket generation client 104 of FIG. 1 may be provided in plural number, respectively.

[Hardware Configuration of Image Forming Apparatus]

FIG. 2 is a block diagram showing a hardware configuration of the image forming apparatus 101 of FIG. 1.

In FIG. 2, the image forming apparatus 101 is provided with a CPU 201 for control, a RAM 202 providing a work area for the CPU 201, and a reading device 203 reading an image.

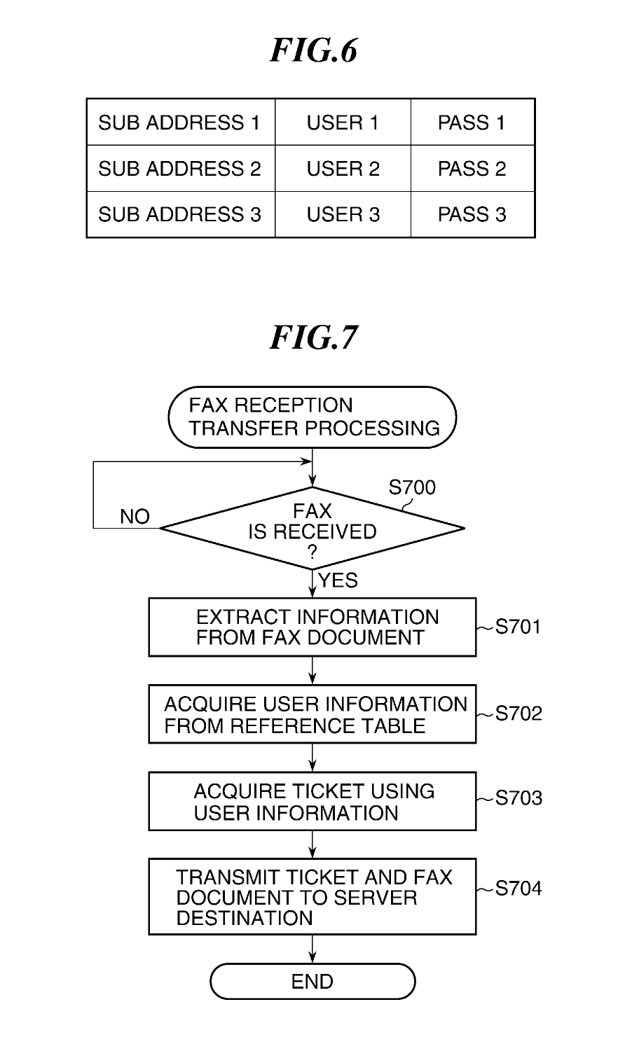

The image forming apparatus 101 is provided with a storage device 204 (or HDD, NVRAM, or the like) which stores an image processing program and various setting values, a user input device 205 for use in command input by a user, a UI display device 206 performing image display, and a network device 207 communicating with other equipment through a network. Those components 201 to 207 are connected to each other through a main bus 200. One of the RAM 202 and the storage device 204 stores therein a reference table of FIG. 6 to be described later.

In the present embodiment, unless otherwise specified, in the image forming apparatus 101, the CPU 201 of a controller controls the general operation of the device and executes various processings. Namely, the CPU 201 controls the RAM 202, the reading device 203, the storage device 204, the user input device 205, the UI display device 206, and the network device 207 through the main bus 200. The UI display device 206 may also serve as the user input device 205.

[Hardware Configuration of Server]

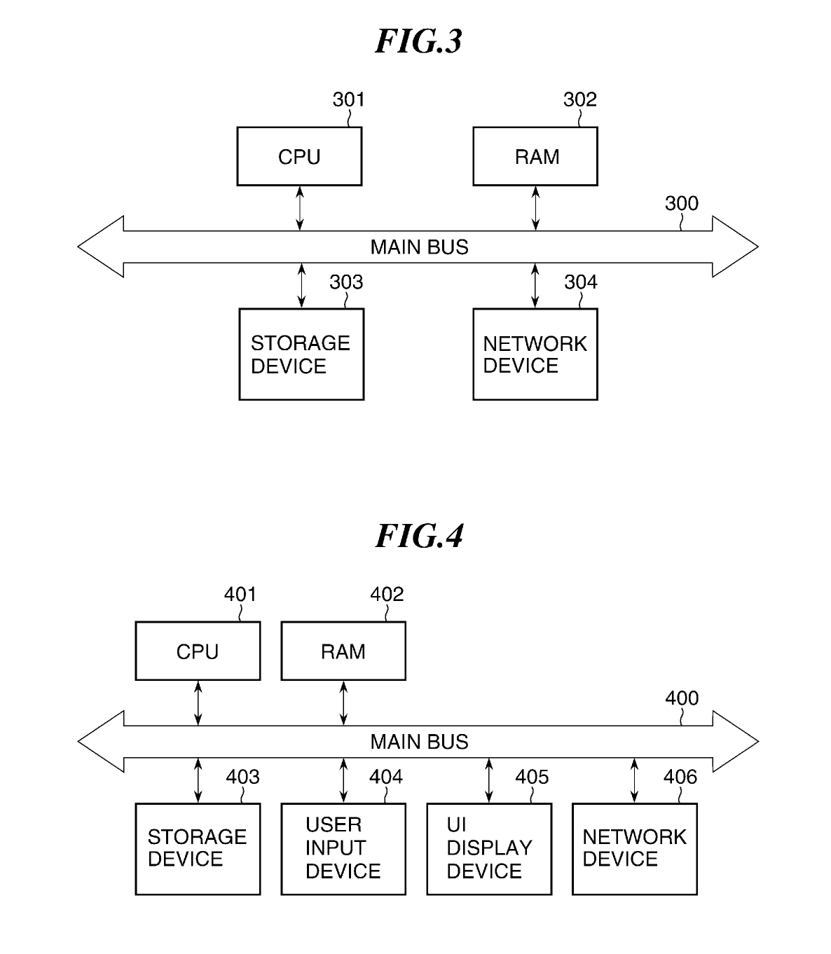

FIG. 3 is a block diagram showing each hardware configuration of the ticket management server 102 and the processing server 103 in FIG. 1.

In the present embodiment, unless otherwise specified, in one of the ticket management server 102 and the processing server 103, a CPU 301 controls a RAM 302, a storage device 303, and a network device 304 through a main bus 300.

The server of FIG. 3 is provided with the CPU 301 and the RAM 302 providing a work area for the CPU 301 and executes programs of various processings associated with the functions of the server. The server is provided with a storage device 303 storing setting and a network device 304 communicating with other equipment through a network. These components are connected to one another through the main bus 300.

[Ticket Generation Client Configuration]

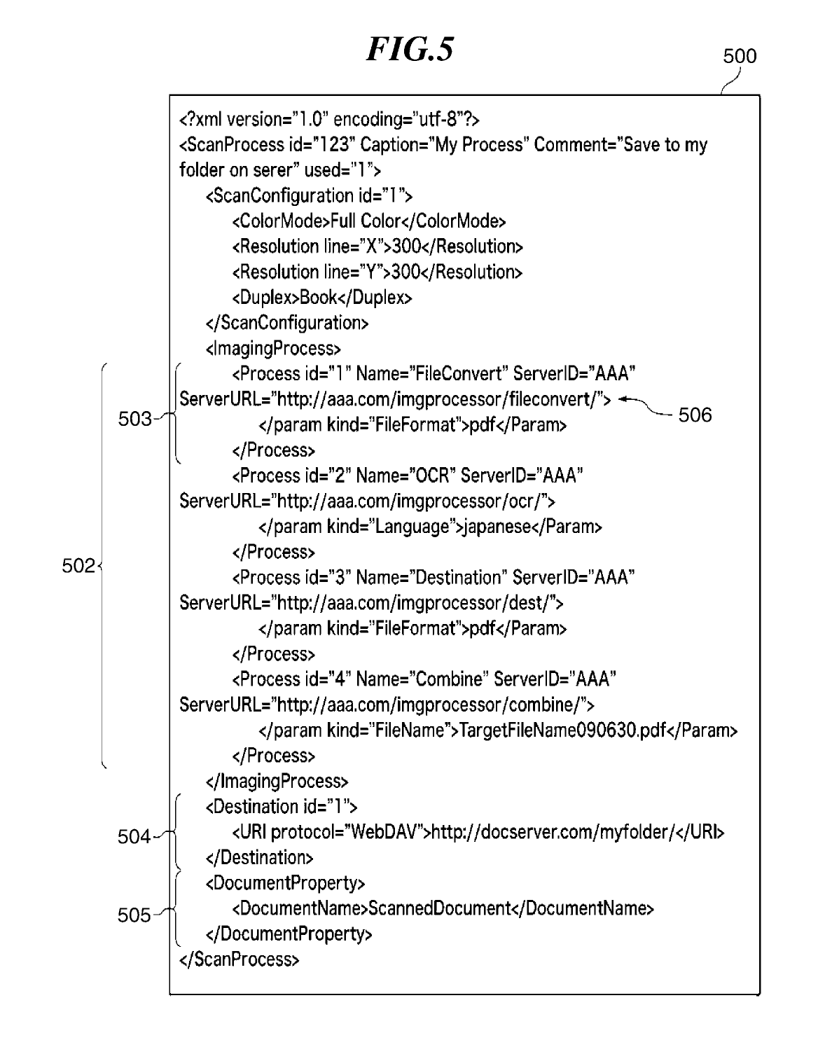

FIG. 4 is a block diagram showing a hardware configuration of the ticket generation client 104 of FIG. 1.

In FIG. 4, the ticket generation client 104 is provided with a CPU 401, a RAM 402 providing a work area for the CPU 401, a storage device 403 (or may be a hard disk or NVRAM) which stores various programs used in the ticket generation client 104 and various setting values, a user input device 404 through which a user inputs a command, a UI display device 405 performing screen display, and a network device 406 communicating with other equipment through a network. These components 401 to 406 are connected to each other through a main bus 400.

The CPU 401 controls the RAM 402, the storage device 403, the user input device 404, the UI display device 405, and the network device 406 through the main bus 400, unless otherwise specified.

[Ticket Configuration]

FIG. 5 is a view which is useful in explaining a configuration of the ticket generated by the ticket generation client of FIG. 1.

In FIG. 5, a ticket file 500 is generated in the ticket generation client 104 to be stored in and managed by the ticket management server 102. The ticket management server 102 manages a plurality of tickets similar to the ticket file 500. The ticket file 500 has flow setting 502, a storage destination 504, and document attribution 505 described therein.

The flow setting 502 includes process setting 503 and a procedure of the processing server 103 processing image data read in the image forming apparatus 101.

The process setting 503 includes the order of process, the name of processing, a server URL to be processed, and setting information required for processing. The process settings 503 may be provided in plural number.

The storage destination 504 includes an address at which image data processed in the process setting 503 is stored, a folder pass, and a communication protocol.

The document attribution 505 includes attribute information associated with image data to be stored. The attribute information includes a document name, an updated date, and a creator name.

In the present embodiment, although the ticket file 500 is XML, the file format is not limited to XML as long as it can express structured data.

[Configuration of User Information Reference Table]

FIG. 6 is a view which is useful in explaining a configuration of a user information reference table utilized by the image processing system of FIG. 1.

The user information reference table of FIG. 6 is referred using information extracted from a FAX document received by the image forming apparatus 101.

The user information reference table of FIG. 6 includes a sub address and a user's name and password as user information. The user information can be obtained with the use of the reference table, using the sub address as a key.

In the present embodiment, although the sub address is used as the information for specifying the user information, information such as a sender telephone number, a sender name, and an e-mail address may be used as long as it can be obtained from the FAX document. For the information for specifying the user information, a combination of information such as a sender telephone number, a sender name, and an e-mail address may be used.

In the present embodiment, although the user information reference table is held in the RAM 202 or the storage device 204, the user information reference table may be held in an external storage device. In the present embodiment, the user information reference table is described as previously provided fixed data. However, a manager or a user may change the contents described in the reference table through the user input device of the image forming apparatus 101 or on a PC connected through a network.

[Ticket Transfer Processing in Image Forming Apparatus]

FIG. 7 is a flowchart showing the procedure of a FAX reception transfer processing that is executed by the image forming apparatus of FIG. 2.

In the processing of FIG. 7, FAX may be a FAX service through the Internet. The image forming apparatus 101 may receive an image as an e-mail attachment file in addition to FAX.

In the FAX reception transfer processing, when a receiving unit of the image forming apparatus 101 receives a FAX (YES to step S700), information for specifying a user receiving the FAX and the ticket to be used is extracted from the FAX document (step S701). In the present embodiment, a sub address is used as the information for specifying the user information. As described above, as the information for specifying the user information, the information such as a sender telephone number, a sender name, and an e-mail address may be used, or a combination thereof may be used.

Next, the information of the user receiving the FAX is obtained from the information extracted in step S701 and the reference table (FIG. 6) held in the image forming apparatus. In the present embodiment, a line corresponding to the sub address of the received FAX document is obtained (step S702).

Subsequently, the ticket is received from the ticket management server 102 using the user information (step S703). At that time, user authentication information (the user name and password in the present embodiment) determined in step S702 is transmitted, and the ticket associated with a user is received.

Next, a destination 506 that specifies a processing server is obtained from the first process setting 503 (FIG. 5) described in the ticket according to the ticket received in step S702. Further, the ticket received in step S703 and the FAX document received in step S700 are transmitted to the server destination 506 (step S704), followed by the procedure terminating.

[Ticket Execution Processing of Processing Server]

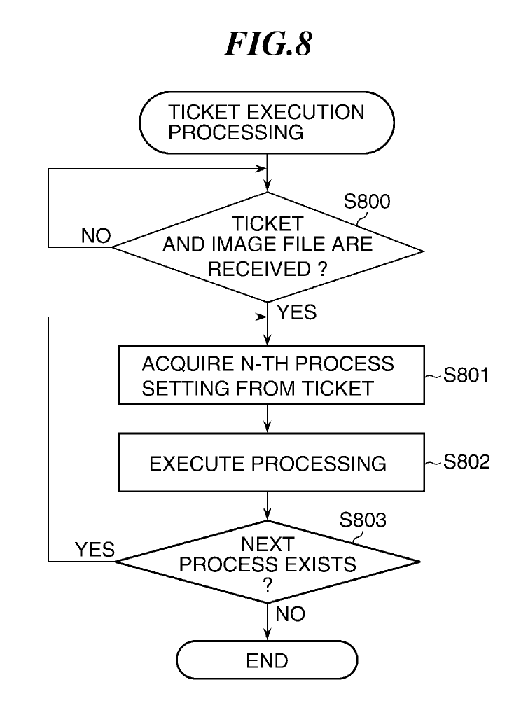

FIG. 8 is a flowchart showing the procedure of a ticket execution processing that is executed by the processing server of FIG. 3.

In FIG. 8, when the processing server 103 receives the ticket and a FAX-received image file from the image forming apparatus 101 (YES in step S800), the n-th (n=1^{st} in the first case) process setting 503 is obtained from the received ticket (step S801).

Next, the processing (such as e-mail transmission, file transmission, FAX transmission, and OCR processing) is executed according to the process setting taken out in step S801 (step S802).

Finally, it is determined whether or not the (n+1)-th process exists in the process setting read in step S801 (step S803). When the (n+1)-th process exists, the processing of step S801 and subsequent steps are repeated, and when the (n+1)-th process does not exist, the processing is terminated.

In the image processing system according to the embodiment of the present invention, the FAX transfer processing is realized not through user operation, and, at the same time, post-processing can be executed.

[Specific Example of the Utility of this System]

This system can be utilized as an information management system serving as an information distribution service between the image forming apparatus 101 and the user terminals connected through the network 100.

As a first example of the utility of this system, it is considered to connect an external apparatus having the FAX function and a PC as each user terminal to the image forming apparatus 101, constituting this system used in an office, through the network 100.

In this system, the image forming apparatus 101 receives the image information and the ticket from an external FAX. The received ticket includes the information for specifying a user (such as a sub address, a sender telephone number, a sender name, and an e-mail address) and information associated with image processing.

When the image forming apparatus 101 determines, from the contents of the ticket, that post-processing applied to the received image information and retransmission of the image information to each user are required, the image forming apparatus 101 transmits the received image information and ticket to the processing server 103.

Next, the processing server 103 specifies a user from the attached information for specifying a user. The processing server 103 then acquires the ticket associated with the specified user from the ticket management server 102.

The ticket associated with the specified user includes management information to each user and image processing information to the image data described therein, the management information being previously input by an administrator through the operation of the ticket generation client 104. The management information to each user includes job contents of individual users and discrimination of the image information permitted to be received according to the secret level.

The processing server 103 applies the image processing to the received image information based on the image processing information to the image data described in the ticket.

The processing server 103 provides such an effect that when the management information to each user described in the ticket includes an instruction of retransmitting the image information to a certain user, the processing server 103 automatically retransmits the image information to the user.

In the processing server 103, when the management information to each user described in the ticket includes an instruction of inhibiting the retransmission of the image information to a certain user, the processing server 103 does not retransmit the image information.

In this system described above, an administrator manages whether or not the image information received in the image forming apparatus 101 is retransmitted to the PCs of individual users, and it is possible to easily perform information management that suppresses a leakage of secret information.

In this system described above, the necessary image information transmitted to the image forming apparatus 101 is automatically retransmitted to the PC of each user by the processing server 103. Accordingly, since each user can receive the image information, received by the image forming apparatus 101, by user's own PC without fetching a paper formed with an image, a convenience is enhanced.

Next, a second example of the utility of this system will be described. The second example is different from the first example in that the image forming apparatus 101 performs the function of the processing server 103.

In the second example of the utility of this system, the image forming apparatus 101 receives the ticket including the image information, the information for specifying a user, and the information associated with the image processing from an external FAX.

When the image forming apparatus 101 determines, from the contents of the ticket, that post-processing applied to the received image information and the retransmission of the image information to each user are required, the image forming apparatus 101 specifies a user from the information for specifying a user described in the ticket.

The image forming apparatus 101 then acquires the ticket associated with the specified user from the ticket management server 102.

The ticket associated with the specified user includes management information to each user and image processing information to the image data described therein, the management information being previously input by an administrator through the operation of the ticket generation client 104. The management information to each user includes job contents of individual users and discrimination of the image information permitted to be received according to the secret level.

The image forming apparatus 101 applies the image processing to the received image information based on the image processing information to the image data described in the ticket.

In the image forming apparatus 101, when the management information to each user described in the ticket includes an instruction of retransmitting the image information to a certain user, the image forming apparatus 101 automatically retransmits the image information to the user. When the management information to each user described in the ticket includes an instruction of inhibiting the retransmission of the image information to a certain user, the image forming apparatus 101 does not retransmit the image information.

The constitutions in the second example of the utility of this system other than those described above, the operation, and the effects are similar to those in the first example of the utility of this system, and therefore, the description does not be repeated here.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

In this case, a program code itself, read from a storage medium, realizes the functions of the embodiment, and the program code and the storage medium storing the program code constitute the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Applications No. 2010-151107 filed Jul. 1, 2010 which is hereby incorporated by reference herein in its entirety.

What is claimed is:

1. An image processing system comprising:
an image forming apparatus configured to receive image information, associated with user information for specifying a user, through a public line;
an information processing unit configured to previously generate process definition in which a process to be executed by the image forming apparatus is described; and
a storage unit configured to store the process definition previously generated by the information processing unit,
wherein the image forming apparatus has an acquisition unit configured to specify the user based on the user information extracted from the received image information and acquire the process definition associated with the user, and
the image processing system further comprises a processing unit configured to execute the contents of processing described in the process definition associated with the user acquired by the acquisition part.

2. The image processing system as claimed in claim 1, wherein the user information for specifying the user comprises at least one of a sender telephone number, a sender name, a sub address, and an e-mail address

3. The image processing system as claimed in claim 1, wherein the public line comprises an e-mail communication line.

4. The image processing system as claimed in claim 1, wherein the processing unit comprises a processing server connected to the image forming apparatus through a network.

5. The image processing system as claimed in claim 1, wherein the information processing unit comprises an information processing device connected to the image forming apparatus through a network,
the storage unit comprises a storage device connected to the image forming apparatus through the network, and
the processing unit comprises a processing server connected to the image forming apparatus through the network.

6. The image processing system as claimed in claim 1, wherein the information processing unit comprises an information processing device connected to the image forming apparatus through a network,
the storage unit comprises a storage device connected to the image forming apparatus through the network, and
the image processing device includes the processing unit.

7. An image processing method comprising:
an image forming step of receiving image information, associated with user information for specifying a user, through a public line;
an information processing step of previously generating process definition in which a process to be executed at the image forming step is described; and
a storage step of storing the process definition previously generated at the information processing step,
wherein the image forming step includes an acquisition step of specifying the user based on the user information extracted from the received image information and acquiring the process definition associated with the user, and
the image processing method further comprises a processing step of executing the contents of processing described in the process definition associated with the user acquired at the acquisition step.

8. A non-transitory computer-readable storage medium storing a program for implementing an image processing method, the image processing method comprising:
an image forming step of receiving image information, associated with user information for specifying a user, through a public line;
an information processing step of previously generating process definition in which a process to be executed at the image forming step is described; and
a storage step of storing the process definition previously generated at the information processing step,
wherein the image forming step includes an acquisition step of specifying the user based on the user information extracted from the received image information and acquiring the process definition associated with the user, and
the image processing method further comprises a processing step of executing the contents of processing described in the process definition associated with the user acquired at the acquisition step.
